(19) United States
(12) Patent Application Publication
(10) Pub. No.: US 2012/0081783 A1
(43) Pub. Date: Apr. 5, 2012

(54) DEPTH ADUSTABLE STEREO GLASSES

(75) Inventor: Scott J. Daly, Kalama, WA (US)

(73) Assignee: SHARP LABORATORIES OF AMERICA, INC., Camas, WA (US)

(21) Appl. No.: 12/894,893

(22) Filed: Sep. 30, 2010

(51) Int. Cl. G02B 27/22

(52) U.S. Cl. 359/464

(57) ABSTRACT

A pair of glasses suitable for viewing stereoscopic content from a display includes a left lens to receive a left image from said display and a right lens to receive a right image from said display. A viewer adjustable adjustment mechanism, said as a knob permits adjustment resulting in a directional shifting of the left image with respect to said the image for the stereoscopic image.

### CROSS-REFERENCE TO RELATED APPLICATIONS

None

### BACKGROUND OF THE INVENTION

The present invention relates generally to glasses for a stereoscopic display.

McDowall et al, U.S. Pat. No. 6,924,833, disclose a system that is primarily directed to accommodating different viewer positions for a three dimensional stereoscopic display (mostly terms of angle from center view). This system is designed for a shuttered glasses system, where the viewers position is determined using a sensor located on the display. Based upon the viewer's position the digital three dimensional image (as mapped to the display) is changed. The system can accommodate multiple viewers by reducing eh duty cycle (when the shutters are open on a particular pair of stereo glasses) shown to each pair of stereo glasses, so that they can multiplex the views by not letting the duty cycles overlap, and by changing the digital image for each duty cycle. Unfortunately, this technique is only applicable for shuttered glasses, requires very high frame rates to accommodate multiple viewers, tends to result in excessive flicker, and tends to result in under sampled motion.

What is desired is a technique for depth adjustment that is individually adjustable for each viewer when viewing a shared display.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates Percival zone of visual comfort for three sizes.

FIG. 2 illustrates vergence-accommodation depth of field comfort zone.

FIG. 3 illustrates a variable offset prism.

FIG. 4 illustrates Snell's law.

FIG. 5 illustrates a Risley prism.

FIG. 6 illustrates stereo glasses with depth adjustment knob.

FIG. 7 illustrates a stereo glasses system.

FIG. 8 illustrates image offset element of stereo glasses.

FIG. 9 illustrates a an adjustment element with a stereo modulator for stereo glasses.

FIG. 10 illustrates a display with stereo adjustment.

### DETAILED DESCRIPTION OF PREFERRED EMBODIMENT

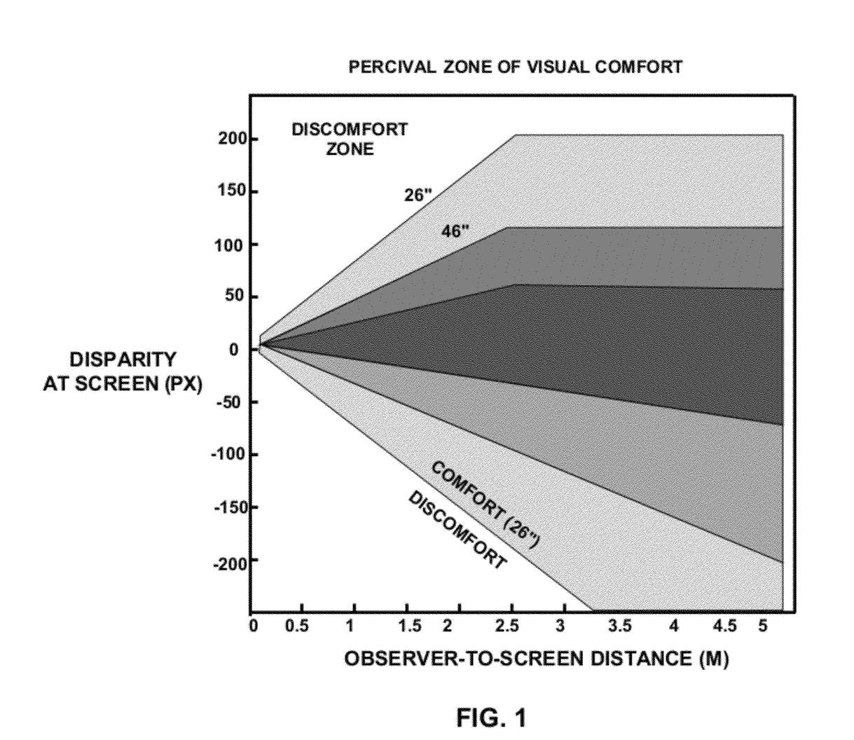

Referring to FIG. 1, the comfort ranges (based on the vergence-accommodation depth-of-field mismatch) is illustrated for three different display sizes. The horizontal axis is the observer physical viewing distance (e.g., meters), and the vertical axis is the maximum allowed pixel disparity (across both eyes of the viewer which creates the depth illusion). The depth illusion causes the vergence eye movements to ‘point’ to a particular depth. If that depth position is outside of the depth of focus of the eyes accommodation to the display, then there is a mismatch because either the display will look blurred, or the image will show up with double edges (depth fusion cannot be effectively made). This mismatch leads to discomfort that often nearly immediately and nearly always over an extended time period. Three displays are shown (26 inch, 46 inch, and 108 inch) and the corresponding comfortable ranges of pixel disparities may be determined from the vertical axes, depending on the viewing distance of the viewer. All three displays are assumed to have the same digital resolution (fullHd=1920×1080), merely for simplicity of illustration. Three dimensional media content is generally unaware of the viewer distance and display size, and commercial expectations tend to result in a single version being mastered onto disc or broadcast with a single depth (disparity in pixels) range. Since the comfortable ranges change depending on the display and viewer distance, this means an adjustment is needed for the display to optimize performance. Positive disparities refer to when the image appears behind the display surface to the viewer, and negative values refer to when the image will appear in front of the display.

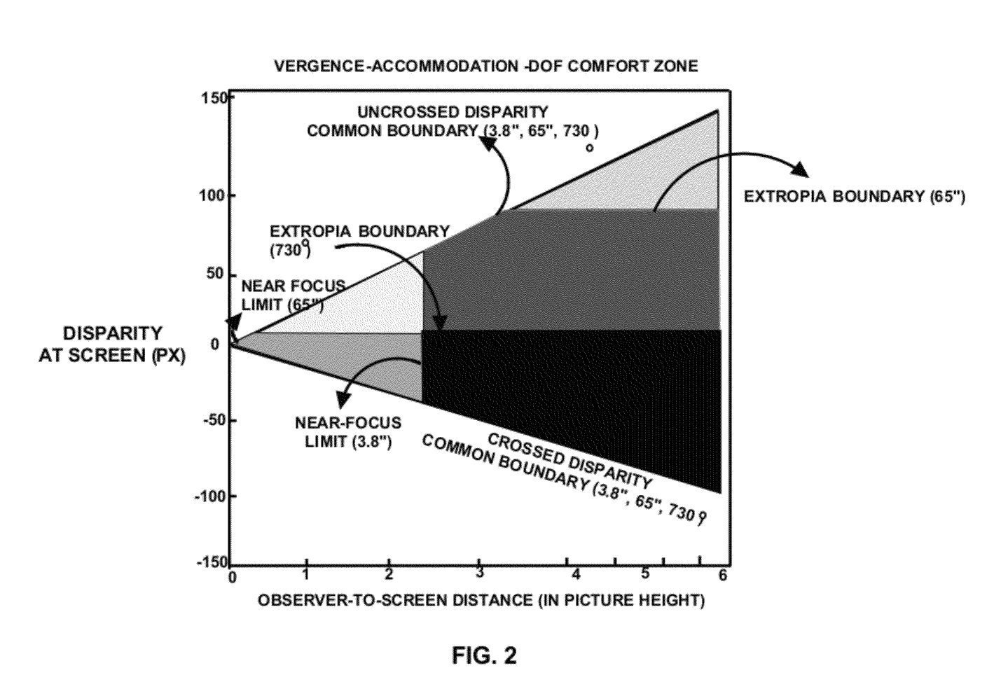

FIG. 2 illustrates a similar analysis, but for a wider range of display sizes (e.g., mobile display size up to movie theatre size), and the viewing distance is presented in units of picture heights, since it is expected that viewers may be seated at the system display specification (e.g., 3 picture heights) independent of the size of the display. This makes the line of negative disparities align, suggesting there will be no variation with display size. However, there are still differences, depending on the actual viewing distance. Moreover, for the positive disparities, there is a horizontal line called the emmetropia boundary (past which the eyes would actually diverge, becoming very uncomfortable). This line becomes very low for movie theaters. So if, three dimensional movies are digitally mastered for the theatre, and then simply written onto home media or broadcast to the home without remastering, the depth constraints in the theatre are too tight for the preferred home viewing conditions. This means the depth at the home viewing conditions will tend to look very shallow, compared against what is possible without discomfort. Accordingly, the depth adjustment should be performed with respect to the display.

In addition to the desire for display-specific adjustments, there are adjustments based on viewing distance. In many situations, the range of viewing distances of viewers seeing a single display can vary widely throughout the room. In addition there are individual preferences on the depth range particular viewers prefer. In some cases, the stereoscopic image may appear as a “stage style” where the depth remains entirely behind the display. In other cases the stereoscopic image may appear as a “hologram style” where the depth entirely protrudes in front of the display. In other cases, viewers may prefer a mix of the “stage style” and the “hologram style”.

Since the stereoscopic appearance of the image has such variability, and is further based upon personal preference, it is desirable that the stereoscopic image be presented in such a manner that are tailored to the particular viewer. While such adjustments could be made exclusively by the display in some manner, it is more desirable that each viewer be able to achieve individualized depth adjustments. Such individual depth adjustments may be performed by modification of images received by the stereoscopic glasses. The depth adjustment may be accomplished by horizontal shifting (or otherwise directional shifting) of the left and right eye images relative to each other. This shifting causes a shift in the depth observed by the viewer, but does not change the range. As a result, the depth can be effectively shifted out of the display screen or more behind the display screen, as desired by the particular viewer. The shifting may be result of adjustments made to, or adjustments transmitted to, the optical glasses used by the viewer.

The preferred technique uses an optical device, and thus is a passive structure. For example, the optical device may be a variable offset prism, where the viewer turns a small knob or moves a level, or otherwise some adjustment on the glasses (or otherwise associated with the glasses). For the variable offset prism, and the viewer turns a small knob or lever on the glasses to adjust the spacing between the prisms. The spacing change causes a horizontal lateral shift in one eye, or a relative shift between both eyes, which shifts the depth. Fortunately, only a small lateral shift at the plane of the eye glasses is needed, so the prisms can be small and lightweight, and not making the glasses too thick.

An alternative embodiment uses a Risley prism, where the change in depth is affected by rotation of ½ of the prism pair (in a single ‘lens’). Another alternative embodiment uses a Fresnel pattern, which tends to be thinner and lighter. A further embodiment includes a voltage controlled liquid crystal lens to cause an angle change.

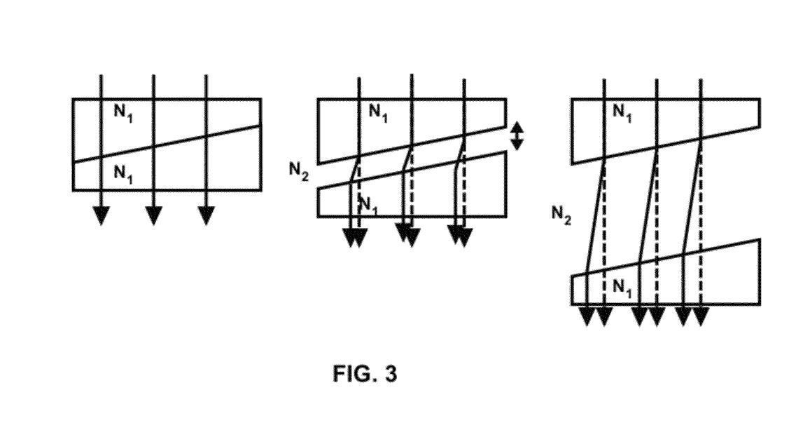

FIG. 3 illustrates the light path through a variable offset prism pair. The pairs are set in opposing angle. As the distance between the prisms increases, the lateral offset of the light path increases. In this case, the index of refraction, n, is different between the prism and the gap. The gap may be assumed to be air, and the prism is preferably glass or plastic. Plastic is the preferred material, since its index of refraction larger and it is lightweight.

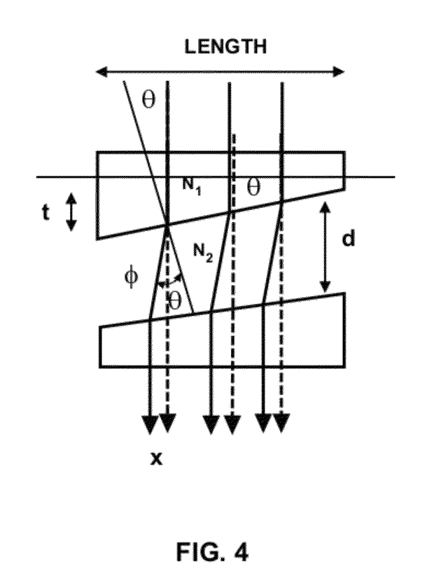

FIG. 4 illustrates the angles, and facilitates explanation in terms of Snell's law. The basic math centers on Snell's law and the geometry of the prisms. Snell's law of refraction stated in terms of FIG. 4 is:

si [symbol] sin [symbol] =n2/ [symbol] 1; ( [symbol] )

Solving for [symbol] gives;

φ=sin⁻¹((n2/n1)sin θ). (2)

Of less interest is the offset from the perpendicular at the exiting 1^{st} prism surface, but of more interest is the angular offset from the direct entrance optical axis (dotted line). This offset angle is [symbol] −θ. Also of interest is the lateral offset x, as a specified design parameter based on the comfort system analysis (offset in pixel at the display surface as mapped to the equivalent offset at the stereo glasses surface). For small angles caused thin prisms (such as [symbol] <5 degrees), the following equation approximates the lateral ray offset of the combined prism system:

x/d=tan(φ−θ) (3)

x=d tan(φ−θ) (4)

Finally, the system can include the parameters for the lens thickness and prismatic angle (assuming a pure prism shape going to a tapered point), as

Length=thickness/tan(θ) (5)

[symbol]

=tan⁻¹(t/length (6)

Combining equations 2, 4, and 6 gives:

d=x/[tan(sin⁻¹({n1/n2} sin({tan⁻¹(t/l)})−tan⁻¹(t/l) (7)

in order to determine the spacing distance between the 2 prisms given all the other parameters as input.

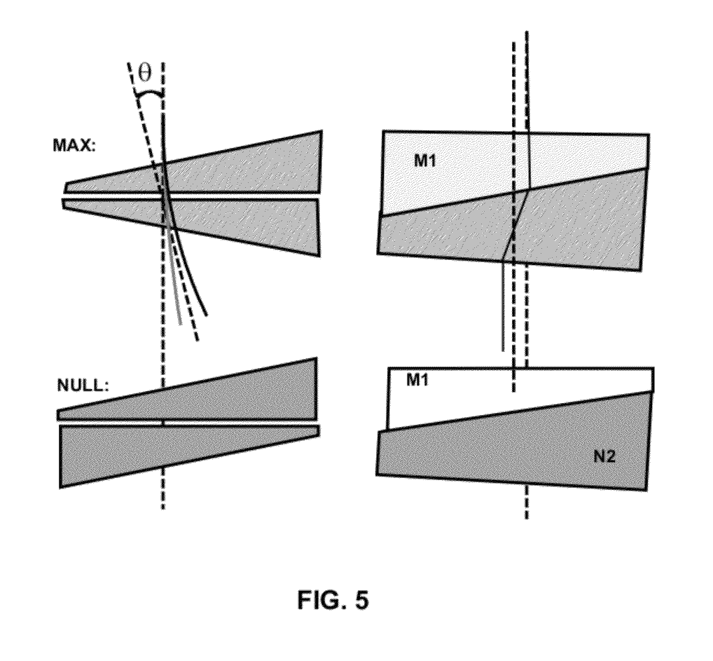

The Risley prism does not cause lateral offset of the light path but actual refraction (bending). Unlike a lens, all the rays bend in the same direction, so it has a similar effect of the rays going into the eye as caused by the variable offset prism. The technique makes use of two circular prisms laid in opposing directions. If they are exactly opposing, then there is no bending of the ray (bottom left side of FIG. 5). By rotating one of the prism pair, the light will begin to bend, due to Snell's law, at the interface of the glass and air. The max bending position is shown in the top left in FIG. 5. The refraction in between the prism pieces is generally ignorable because the gap is so thin. As with all prisms, there is some chromatic divergence of the light rays. This is undesirable, so some type of chromatic aberration coating may be used, if desired. The right side of FIG. 5 shows a technique using two different indices of refraction for each element.

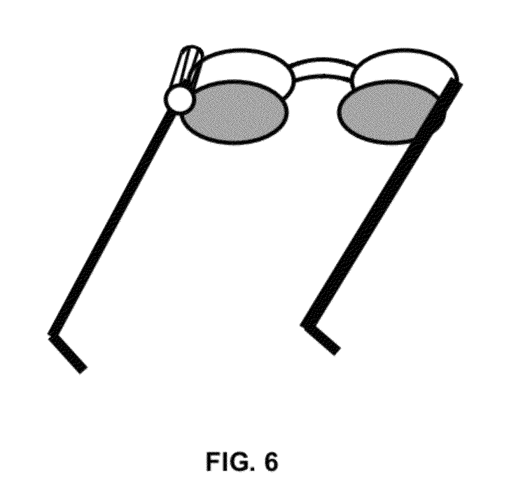

Referring to FIG. 6, it is preferable to mount a lateral ray-shifting optical element onto each eyepiece of a pair of stereo glasses. For purposes of discussion, the term ‘lens’ is being used even though prisms are not true lenses. The viewer can make an adjustment on the glasses that will offset the image in one eye relative to another. This will have the same effect as the digital horizontal offset applied to the displayed image to cause a shift in the perceived depth image. Since the adjustment is on the glasses, each viewer can make their own adjustment, as befitting the display size, viewing distance, and personal preference. Turing the knob one direction will shift the depth image either out of the display, and the other direction will make it recede back behind the display. Also, the glasses may include adjustment controls for each eye, or linked distributed adjustments, such as splitting the offset across both eyes.

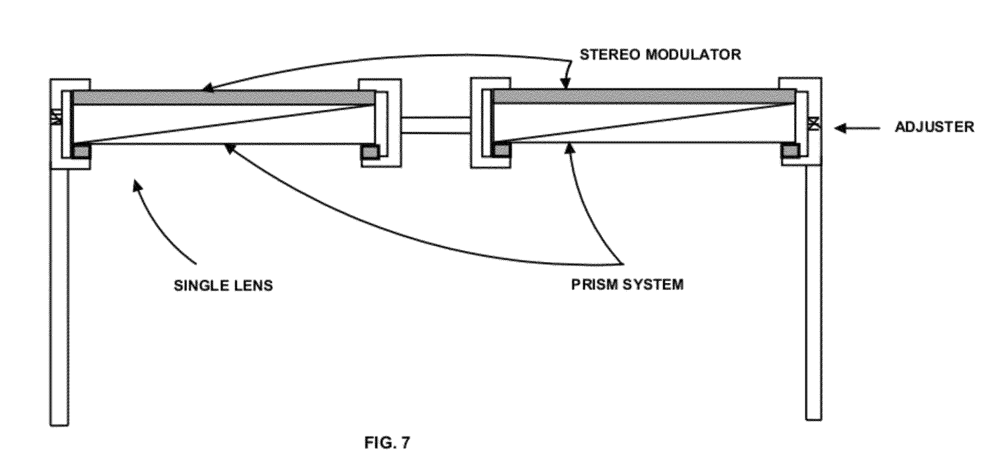

FIG. 7 below shows the adjustable-depth stereo glasses in a top-down view. The ‘stereo modulator’ element can either be the active portion of the shutter glasses (an LC switchable layer), a passive polarizer, or other element. The incoming light first goes through the stereo modulator before the prisms systems (which cause the offset that adjusts the depth). The order may be reversed, if desired.

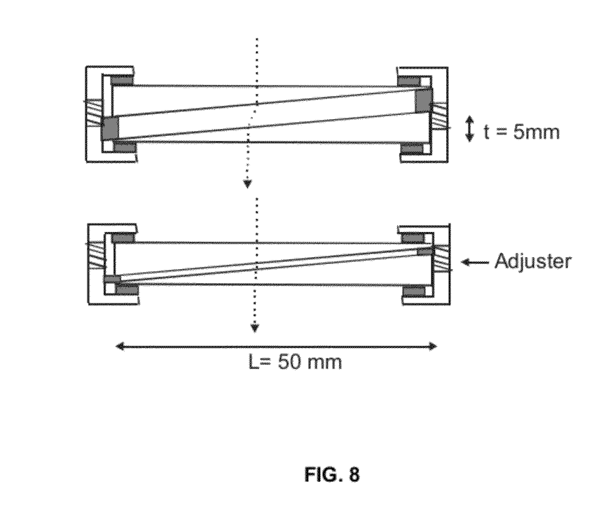

Each eyepiece of the glasses may be referred to as a ‘lens’, for ease of discussion, even though they are not lenses in the truest sense of having a focal depth and virtual image. FIG. 8 illustrates a close-up of a single lens with just the light ray offsetting elements. The gray elements are spacers and supports, and may be compressible/expandable. Other mechanical techniques may also be used to allow for support and movement.

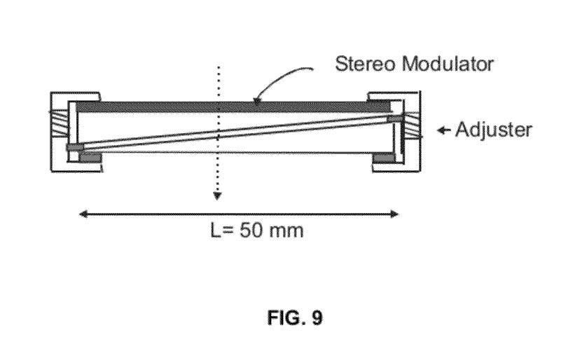

FIG. 9 illustrates a close-up of a single lens, further including the stereo modulation element, e.g., optical components that causes stereo image isolation (polarizer or switchable LC shutter element). The stereo modulator may be a polarizer as in passive stereoscopic glasses, or an LC shutter, as in the active glasses. A principal drawback of this approach is that the distance should be adjusted uniformly across the entire lens. This means the adjustment approaches should surround the lens to distribute the effect of the adjustment, or be on opposing sides

The thickness of the prism and the spacing used to generate the amount of lateral offset desired for the expected range of depth adjustment may be based upon the optical indices of glass and air. If certain plastics are used, the thickness may be reduced (but chromatic aberration may tend to increase). The first step is to analyze the lateral offsets desired for the display. A shift of about 64 pixels generally the maximum needed to adjust for a full range of comfort and preference.

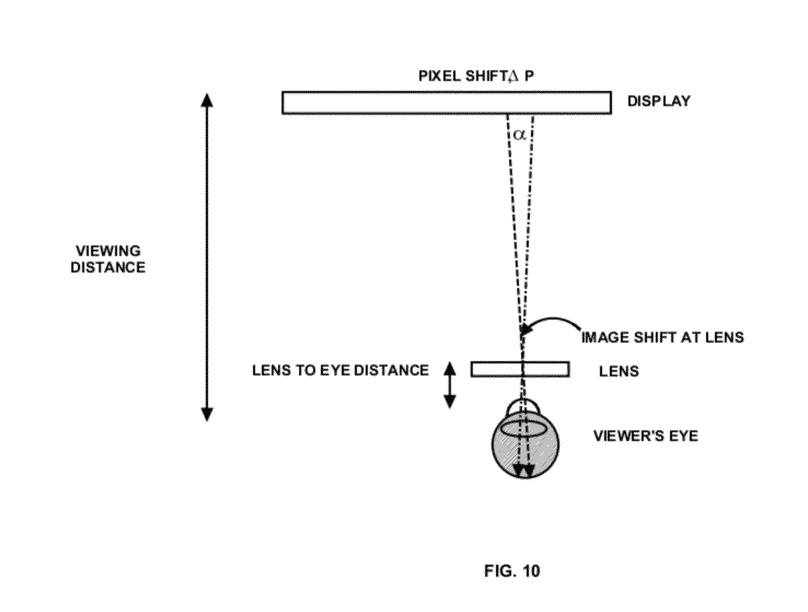

FIG. 10 illustrates the display with the intended pixel shift (applied to only one off the stereo image pair), the viewing distance, and the angle of the shift at the eye caused by the pixel shift on the display. The angle α, normally caused by a shift on the display, is what one would like to impose on the image at the eye-glasses plane. Typically, the distance from the lens to the eye is about 15 mm. The following table shows exemplary offsets at the glasses plane to match a 64 pixel shift at the display plane for a series of viewing distances:

| Viewer | VD in | angle/ | angle offset | offset at |
|---|---|---|---|---|
| dist | pixel units | pixel | 64 pix (α) | glasses |
| 1H | 1080 | 0.053 deg | 3.39 deg | 0.89 mm |
| 2H | 2160 | 0.027 | 1.69 | 0.44 |
| 3H | 3240 | 0.018 | 1.13 | 0.29 |
| 4H | 4320 | 0.013 | 0.84 | 0.22 |
| 6H | 6480 | 0.009 | 0.57 | 0.15 |

The 1H case is set aside, since at that distance it is nearly impossible to have more than one viewer, so doing the depth adjustment on the display makes more sense. From the table, the extreme case are for the 2H (harder to achieve) and the 6H (easier to achieve, sinc the distances are very small).

Based on analysis of equation 7, and a starting point of a stereo glass element of 50 mm across (i.e for each eye), and using standard glass with an index of refraction n1 of 1.3, and an air gap with index of refraction of 1.0, an optimum prism thickness of 5 mm gives a maximum air gap of 4.5 mm to 13.mm (for 6H to 2H viewing distances, respectively). In that case, the combined thickness of the double-prism system (=d+t) is 9.5 mm for the 6H viewing distance, and 18 mm for the 2H case.

One method to reduce the thickness is to either increase n1 or reduce n2. Glass has an index of refraction of 1.33, and the other materials having higher indices of refraction (plastic of 1.460; Plexiglas of 1.50; polystyrene of 1.55; prase of 1.540; prasiolite of 1.540; prehnite of 1.610; and prousite of 2.790), and will result in a thinner total thickness of the adjustment elements.

Alternatively, using a Risley prism causes an angular change in the light rays, which is the final effect, even with the variable offset prism method. That is, the offset at the glasses location on the optical axis results in an angular change entering the eye. The Risley prism technique results in an angular offset at the glasses position. Such an approach has the advantages that no air gap is needed, and no change in physical thickness with adjustment. The adjustment is a rotation, so there is no problem in adjusting spacing uniformly across the lens.

Alternatively, Fresnell film may be used to cause the angular change, which tends to be generally thinner.

Alternatively, an active LC lens may be used which is controllable by a voltage, and used to cause a shift or ‘pseudo-vergence’.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A pair of glasses suitable for viewing stereoscopic content from a display comprising:
(a) a left lens to receive a left image from said display;
(b) a right lens to receive a right image from said display;
(c) a viewer adjustable adjustment mechanism;
(d) modification of said adjustment mechanism resulting in a directional shifting of said left image with respect to said right image for said stereoscopic image.

2. The glasses of claim 1 wherein said adjustment mechanism is attached to said glasses.

3. The glasses of claim 1 wherein said adjustment mechanism is suitable to result in a stage style view of said stereoscopic content.

4. The glasses of claim 1 wherein said adjustment mechanism is suitable to result in a hologram style view of said stereoscopic content.

5. The glasses of claim 1 wherein said viewer adjustable adjustment mechanism is a passive structure.

6. The glasses of claim 1 wherein said viewer adjustable adjustment mechanism is an active structure.

7. The glasses of claim 5 wherein said passive structure is a variable offset prism.

8. The glasses of claim 7 wherein said variable offset prism is capable of being adjusted using at least one of a knob and a lever.

9. The glasses of claim 5 wherein said passive structure is a risley prism.

10. The glasses of claim 5 wherein said passive structure uses a Fresnel pattern.

11. The glasses of claim 6 wherein said active structure is a liquid crystal lens.
